(19) United States
(12) Patent Application Publication
(10) Pub. No.: US 2017/0267524 A1
(43) Pub. Date: Sep. 21, 2017

(54) INCREASING HYDROGEN RECOVERY FROM CO + H2 SYNTHESIS GAS

(71) Applicant: GTLpetrol, LLC, New York, NY (US)

(72) Inventor: Rodney J. Allam, Wiltshire (GB)

(21) Appl. No.: 15/338,073

(22) Filed: Oct. 28, 2016

Related U.S. Application Data
(60) Provisional application No. 62/248,495, filed on Oct. 30, 2015.

(51) Int. Cl. C01B 3/50; C01B 3/56; B01D 53/047; C01B 3/12

(52) U.S. Cl. CPC C01B 3/506; C01B 3/12; C01B 3/56; B01D 53/047; C01B 2203/0283; C01B 2203/042; C01B 2203/046; C01B 2203/0475; C01B 2203/147; B01D 2257/504; B01D 2256/16; B01D 2259/416

(57) ABSTRACT

The GTLpetrol Process for Maximum H2 Production. The GTLpetrol process uses a proprietary combination of two stage pressure swing adsorption hydrogen purification plus a C02 condensation removal step to give H2 recoveries in the range of 95% to 98% based on H2+CO from synthesis gas generation.

### CROSS REFERENCE TO RELATED APPLICATIONS

This application claims the benefit of priority of U.S. Application Ser. No. 62/248,495, filed on Oct. 30, 2015, which is incorporated by reference herein in its entirety.

### TECHNICAL FIELD

This invention relates to increasing hydrogen recovery.

### BACKGROUND

CO+H2 synthesis gas at pressures generally in excess of 30 bar can be produced from natural gas using a variety of processes.
Catalytic stream-natural gas reforming.
Auto-thermal reforming over a catalyst using steam, pure oxygen and natural gas feed.
Partial oxidation of natural gas with pure oxygen.
A two stage process involving an ATR or a PDX first stage followed by a second stage steam/natural gas heated reformer arranged either in series or parallel with the first stage. This configuration is used in the GTLpetrol syn-gas production process which features heat and process integration with a gas turbine producing power for oxygen production plus process heating.

In all these cases the product will be a CO+H2 synthesis gas which must then be processed in a catalytic CO shift conversion reactor in which CO reacts with excess steam producing H2 and C02. The problem in general is to maximise the production of pure H2 from the CO+H2 feed from synthesis gas generation.

### SUMMARY

The GTLpetrol Process for Maximum H2 Production. The GTLpetrol process uses a proprietary combination of two stage pressure swing adsorption hydrogen purification plus a C02 condensation removal step to give H2 recoveries in the range of 95% to 98% based on H2+CO from synthesis gas generation. The system is based on the following sequence:

1. Catalytic shift conversion of CO plus steam to C02+H2.

CO+H₂O=CO₂+H₂

This can be any configuration of high, medium or low temperature, one or two stage with either internal or external heat recovery.

2. Removal of maximum recovery of H2 in a first stage PSA unit resulting in typically 88% of the hydrogen as a pressurised product at less than 50 ppm total impurity.

3. Compression of the PSA waste gas from 1.2 bar to original CO+H2 feed pressure. The gas stream will typically contain over 60% C02.

4. Drying the gas stream and cooling it to within 2° C. of the C02 freezing point, about −54° C., separating the C02 which is re-vaporised to provide cooling and refrigeration. This whole system is far cheaper and far more efficient than a conventional chemical or physical solvent absorption process for C02 removal.

The use of the condensation C02 removal route is possible because firstly, the C02 concentration in the PSA off-gas is so high and secondly because the removal of C02 enriches the H2 concentration to a level high enough for a second PSA to be used for further H2 recovery. Two important features of the low temperature C02 route should be particularly noted.

4.1 The C02 separated as a liquid at low temperature leaves a gas stream containing virtually all other components including the H2 at the high feed gas pressure suitable, after heat recovery, for feed to a second PSA.

4.2 The gas stream will contain a partial pressure of C02 of about 6 bar to 7 bar which can be separated from H2 in the second PSA.

NOTE that the use of a low temperature C02 removal system means that it may be economic to only use a single stage CO shift converter upstream of the first PSA and then process the off-gas from the C02 removal unit in a second stage CO shift reactor producing more H2 and C02 since the CO concentration will have been increased by a factor of about 6 when only 90% of the CO is converted in the first stage PSA giving a much smaller cheaper unit and an overall higher CO conversion to H2.

5. Recovery of H2 in a second stage PSA leaving a waste gas containing residual H2 plus the methane slip from the syn-gas generation step plus the remaining C02. H2 recovery overall will be above 95% of total H2+CO produced in the syn-gas generation system and more typically will be about 97%. The H2 production from the second PSA will be at approximately the same pressure and purity level as in the first PSA.

The economic value of this system can be summarised as follows:

1. The increase in H2 recovery leads to a significant reduction in the energy required to produce a quantity of H2 using natural gas feed depending on the method used for CO+H2 synthesis gas production.

2. The system is ideal for use with an oxygen based CO+H2 synthesis gas production system when the hydrogen is to be used for ammonia production. N2 at high purity from the cryogenic air separator can be mixed with the pure H2 and no purge gas purification system will be required since no insoluble inerts will accumulate in the ammonia synthesis loop.

3. System can be retrofitted to an existing H2 production plant using a single stage PSA and burning the PSA waste gas in a catalytic steam natural gas reforming furnace allowing approximately 10% increase in H2 production at a very low incremental heat rate.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a flowsheet for the hydrogen production process.

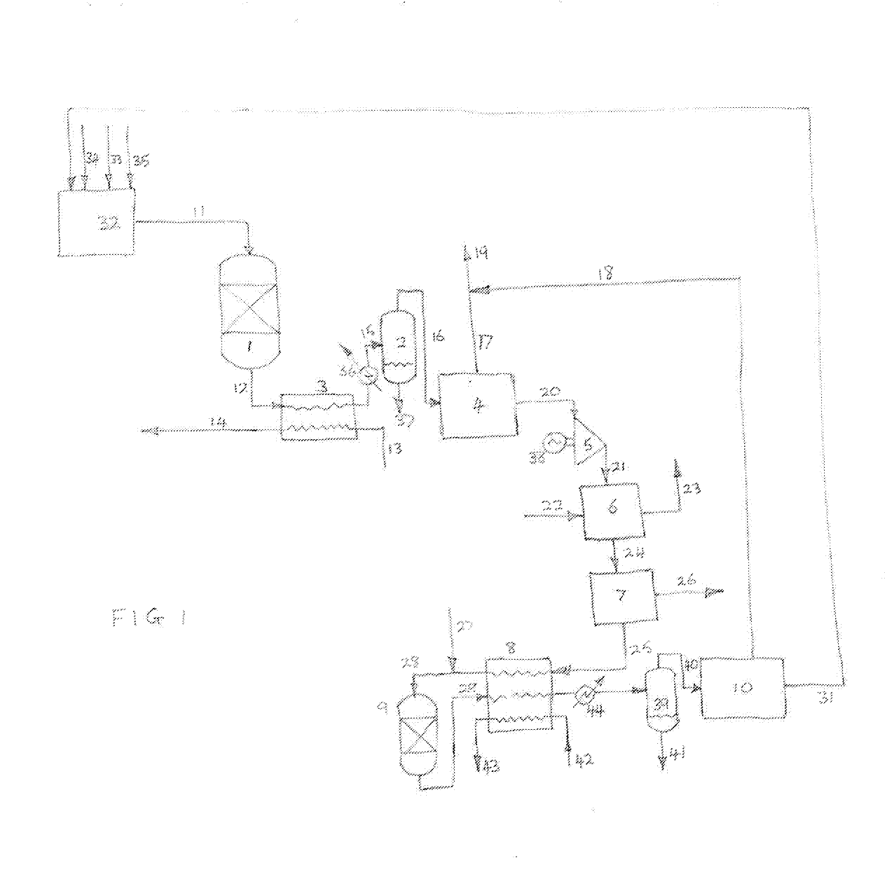

Like reference symbols in the various drawings indicate like elements.

### DETAILED DESCRIPTION

A CO+H2 synthesis gas stream 11 is produced in a synthesis gas generation system 32 fed with streams of optionally preheated feeds natural gas 34, steam 33, oxygen 35 and a low pressure waste stream 31 at 1.2 bar. The pressure of streams 33, 34 and 35 and the pressure of the product stream 11 can be in the range 25 bar to 100 bar depending on the design of unit 32. In general stream 11 will be the product syngas stream leaving the stream generation unit which is part of the synthesis gas generator 32. It will also contain excess steam, some methane which is unconverted in 32 and a small quantity of nitrogen from the natural gas feed and argon associated with the oxygen feed stream 35. The gas stream 11 passes through a catalyst bed in a catalytic shift converter vessel 1 in which 90% of the CO in the feed stream 11 is converted to H2 by reaction with steam. The exit gas stream is cooled to near ambient temperature in one or more heat exchangers 3 which are used to produce heated boiler feed water or medium pressure steam or a combination of both plus a water cooled heat exchanger 36. Liquid water is separated in 2 leaving as stream 37 and the separated gas stream 16 enters a first multibed pressure swing adsorption unit 4. The first PSA 4 separates 88% of the hydrogen as a product stream 17 with a total impurity level of 20 ppm (molar) leaving a waste gas stream 20 at 1.2 bar pressure. Stream 20 is compressed to approximately the same pressure as stream 11 in a multi-stage centrifugal compressor 5 driven by an electric motor 38. The compressed cooled stream 21 is dried in a desicant dryer 6 with an inlet and outlet regeneration gas 22 and 23. This regeneration stream could be nitrogen from the cryogenic air separation unit providing oxygen to the synthesis gas generation system 32. The dried compressed stream then enters the C02 condensation unit 7. This unit utilises the system described in GTLpetrol US Patent Publication No. 2011/0023539 which is incorporated in its entirety in this description. In unit 7 the compressed and dried PSA 1 waste gas stream is cooled to about −54° C. and the liquid C02 is separated from the gas stream which contains the H2+CO valuable components. The separation can be assisted by using a small liquid C02 stripping column in place of the separator and described in US patent assigned to Air Products. The partial pressure of C02 in the separated gas stream will be 6 bar to 7 bar. The unit 7 includes a C02 refrigeration system which might be part of a C02 compressor, also included in 7, to raise the C02 pressure for delivery into a pipeline at 100 bar to 200 bar pressure. The C02 stream separated and warmed to near ambient temperature is delivered as stream 26. The warmed gas stream 25 is then heated in economiser heat exchanger 8 to a temperature of 2500 C. A steam stream 27 from synthesis gas generation unit 32 is added and the gas plus steam stream 28 enters a second catalytic CO shift reactor 9 where 90% of the CO is converted to H2 and C02 by reaction with steam. The outlet stream 29 is then cooled in the economiser heat exchanger 8 followed by the water cooler 44 to near ambient temperature. Water separator 39 removes the condensed water stream 41 and the exit gas stream 40 enters a second PSA unit 10. This second PSA separates a hydrogen product stream 18 at approximately the same pressure as the H2 product stream from the first PSA. The combined stream of H2 product 19 is about 97% of the molar flow of H2+CO in stream 11.

### Example

The following Table 1 is based on the mass balance given in US Patent Publication No. 2011/0318251 assigned to GTLpetrol which uses a two stage ATR plus parallel GHR reactor system with an integrated gas turbine co-generation power system.

The first PSA has a H2 recovery of 88%.

The CO conversion in the first reactor is 90% and in the second reactor is 90%.

The second PSA has a H2 recovery of 83%. The basis for Table 1 is 100 mols of feed in stream 11.

TABLE I

| | POINT | | | | | | | | | |
|---|---|---|---|---|---|---|---|---|---|---|
| | 11 | 16 | 17 | 20 | 25 | 26 | 40 | 18 | 19 | 31 |
| CO | 17.7 | 1.8 | 0 | 1.8 | 1.8 | 0 | 0.2 | 0 | 0 | 0.2 |
| H₂ | 44.5 | 60.4 | 53.2 | 7.2 | 7.2 | 0 | 8.8 | 7.3 | 60.5 | 1.5 |
| CO₂ | 3.4 | 19.3 | 0 | 19.3 | 1.8 | 17.5 | 3.4 | 0 | 0 | 3.4 |
| H₂O | 33.0 | 0 | 0 | 0 | 0 | 0 | 0 | 0 | 0 | 0 |
| CH₄ | 1.2 | 1.2 | 0 | 1.2 | 1.2 | 0 | 1.2 | 0 | 0 | 1.2 |
| N₂ + A | 0.2 | 0.2 | 0 | 0.2 | 0.2 | 0 | 0.2 | 0 | 0 | 0.2 |
| Pressure bar | 77 | 76 | 75.6 | 1.2 | 77 | 100 | 76.5 | 76 | 76 | 1.2 |
| Temp ° C. | 32.0 | 30 | 30 | 30 | 30 | 30 | 30 | 30 | 30 | 30 |

Overall H₂ recovery from CO + H₂ is 97.25%

A number of embodiments of the invention have been described. Nevertheless, it will be understood that various modifications may be made without departing from the spirit and scope of the invention. Accordingly, other embodiments are within the scope of the following claims.

What is claimed is:

1. A method, comprising:
catalytically shifting carbon monoxide and water to carbon dioxide and hydrogen;
removing hydrogen from the carbon dioxide and hydrogen in a first stage pressure swing adsorption (PSA) unit;
compressing waste gas from the first PSA unit to an original pressure of the carbon dioxide and hydrogen;
drying and cooling the compressed waste gas to at least proximate a freezing point of carbon dioxide to separate the carbon oxide from the compressed waste gas to produce a gas stream; and
removing hydrogen from the gas stream using a second PSA unit.

2. The method of claim 1, wherein the hydrogen removed from the carbon dioxide and hydrogen in the first PSA is approximately 88% or greater of the hydrogen.

3. The method of claim 1, wherein the hydrogen removed from the carbon dioxide and hydrogen in the first PSA has less than 50 ppm total impurity.

4. The method of claim 1, wherein the gas stream contain a partial pressure of carbon dioxide of about 6 bar to about 7 bar.

5. The method of claim 1, wherein the hydrogen recovery is at least 95% of total carbon dioxide and hydrogen produced.
